(19) United States
(12) Patent Application Publication
(10) Pub. No.: US 2015/0276197 A1
(43) Pub. Date: Oct. 1, 2015

(54) Lamp with Airing Function

(71) Applicant: Sunonwealth Electric Machine Industry Co., Ltd., Kaohsiung City (TW)

(72) Inventor: Alex Horng, Kaohsiung City (TW)

(21) Appl. No.: 14/591,972

(22) Filed: Jan. 8, 2015

(30) Foreign Application Priority Data
Mar. 26, 2014 (TW) 103111278

(51) Int. Cl. F21V 29/60; F21V 33/00; F21V 23/06; F21V 1/00

(52) U.S. Cl. CPC F21V 29/60; F21V 1/00; F21V 33/0028; F21V 23/06

(57) ABSTRACT

A lamp with airing function, which is adapted to be mounted on a fixed object, includes: a base; a lampshade connecting with the base; a light emitter arranged between the base and the lampshade; and a distance holding member having a first connecting end, a second connecting end opposite to the first connecting end, and an axial length between the first and second connecting ends, with the first connecting end connecting with the base and the second connecting end adapted to connecting with the fixed object, wherein an airing gap is formed between the base and the fixed object by the axial length of the distance holding member.

### BACKGROUND OF THE INVENTION

1. Field of the Invention

The present invention generally relates to a lamp with airing function and, more particularly, to a lamp able to form an air channel after settled so as to perform a designed airing function.

2. Description of the Related Art

Referring to FIG. 1, a conventional lamp 8 with ventilator is shown, which includes a cover 81 and a ventilator 82. The cover 81 has a plurality of openings 811 and connects with an end of the ventilator 82. A room is defined and enclosed by the cover 81 and ventilator 82, with a light emitter being received inside the room. Therefore, when the cover 81 is arranged in a ceiling or a wall, with the operation of the ventilator 82, the lamp 8 is able to perform air ventilation via the openings 811 adapted to suck or expel air.

However, in order to smoothly guide the air current by the ventilator 82, the ventilator 82, light emitter and cover 81 have to be coupled with and to match with each other. This requirement leads to complicated assembly steps, which actually result in inconvenience in manufacture. Besides, the openings 811 may also affect the look and strength of the cover 81.

Referring to FIG. 2, another conventional lamp 9 with a ventilator is also shown. The lamp 9 has a centrifugal fan 91 as the ventilator. The centrifugal fan 91 connects with a lampshade 92. The lampshade 92 has a plurality of apertures 921 and is adapted to couple with a light tube for the light emitted by the light tube to transfer through the lampshade 92. Therefore, when the lamp 9 is arranged in a ceiling or wall, the operation of the centrifugal fan 91 can guide airflows to enter into and exit from the lamp 9 via the plurality of apertures 921, so as to provide the airing function.

However, the apertures 921 for the centrifugal fan 91 to smoothly guide the airflows entering into and exiting from the lamp 9 can easily result in decrease of structural strength and look. Additionally, a special design of the lampshade 92 for matching with the centrifugal fan 91 and light tube further leads to inconvenience in manufacture.

### SUMMARY OF THE INVENTION

What is needed is a lamp with airing function able to form an air channel after settled, so that the airing function is achieved without forming any hole in a fixed object in addition to an assembly hole.

Another need is a lamp with airing function able to provide the airing function by adaptation of existed elements in the lamp market.

A further another need is a lamp with airing function able to provide the airing function without forming any through hole in the surface of the lamp, so as to avoid destroying the look of the lamp.

In one implementation, a lamp with airing function, which is adapted to be mounted on a fixed object, includes: a base; a lampshade connecting with the base; a light emitter arranged between the base and the lampshade; and a distance holding member having a first connecting end, a second connecting end opposite to the first connecting end, and an axial length between the first and second connecting ends, with the first connecting end connecting with the base and the second connecting end adapted to connecting with the fixed object, wherein an airing gap is formed between the base and the fixed object by the axial length of the distance holding member.

In this implementation, one or more of the following features may be included: in radial directions perpendicular to the axial length, the distance holding member is located within a range of a combination of the base and lampshade; in radial directions perpendicular to the axial length, the base has a first largest width, and the lampshade has a second largest width smaller than the first largest width; the lamp further comprising another distance holding member, wherein there is a spacing distance between the two distance holding members, and a largest width of a combination of the base and lampshade is defined as a lamp width and larger than the spacing distance; the distance holding members are arranged on a virtual circle, and the spacing distance is a diameter of the virtual circle; the spacing distance is smaller than or equal to ⅘ of the lamp width; in radial directions perpendicular to the axial length, the base has a first largest width, and the lampshade has a second largest width larger than the first largest width; the lampshade has an opening and the base is received in the lampshade and located at the opening; the lamp further comprising a support penetrating the lampshade to connect the lampshade with the base; the base has a coupling portion, the lampshade has a through hole corresponding to the coupling portion, the support has a shaft and a head connecting with an end of the shaft, the shaft extends through the through hole and connects with the coupling portion by another end, and the head supports and positions the lampshade; the head is integrally formed on the end of the shaft; the head is detachably connected with the end of the shaft; the lampshade has a through hole, the support has a shaft and a head connecting with an end of the shaft, the shaft extends through the through hole and integrally connects with the coupling portion by another end, and the head supports and positions the lampshade; an electrical connector is arranged on a periphery of the shaft, and the light emitter connects with the electrical connector; the base has an electrical connector, and the light emitter connects with the electrical connector; the lamp further comprising a fan with a frame and a fan wheel received in the frame; the distance holding member extends through the assembly hole, the second connecting end abuts against an inner side of the fixed object, and the frame is fixed to the second connecting end; an outer edge of the base has a flange covering an outer periphery of the lampshade; a plurality of ornaments is hung on the flange; the base is a bar-shaped plate; the base is a cross-shaped plate; the base is a Y-shaped plate; the base is a round plate; the base is a ring-shaped plate; the distance holding member is a punch-formed member; and the first connecting end is a plurality of supporting ribs with through holes, and the second connecting end is a ring with through holes.

In another implementation, a lamp with airing function, which is adapted to be mounted on a fixed object, includes: a base adapted to connect with the fixed object; a lampshade; a light emitter arranged between the base and the lampshade; and a distance holding member having a first connecting end, a second connecting end opposite to the first connecting end, and an axial length between the first and second connecting ends, with the first connecting end connecting with the base and the second connecting end connecting with the lampshade, wherein an airing gap is formed between the lampshade and the fixed object by the axial length of the distance holding member.

In this implementation, one or more of the following features may be included: in radial directions perpendicular to the axial length, the base has a first largest width, and the lampshade has a second largest width larger than the first largest width; the first largest width is smaller than or equal to ⅘ of the second largest width; in radial directions perpendicular to the axial length, both of the base and distance holding member are located within a range of the lampshade; the lampshade has a through hole, the distance holding member has a rod, the second connecting end has a hole aligning with the through hole, and a head supports the lampshade, extends through the through hole and engages with the second connecting end; an electrical connector is arranged on a periphery of the distance holding member, and the light emitter connects with the electrical connector; the base has an electrical connector, and the light emitter connects with the electrical connector; the lamp further comprising a fan with a frame and a fan wheel received in the frame; the base has an extending rib connecting with a positioning frame for the positioning frame to link the base and the fixed object; the frame of the fan mounts on the positioning frame; the base has an extending rib connecting with the frame; in radial directions perpendicular to the axial length, the extending rib is located within a range of the lampshade; the base has another extending rib, there is a spacing distance between the two adjacent extending ribs, and the lampshade has a second largest width larger than the spacing distance; the spacing distance is smaller than or equal to ⅘ of the second largest width; the base is a bar-shaped plate; the base is a cross-shaped plate; the base is a Y-shaped plate; and the base is a ring-shaped plate

### BRIEF DESCRIPTION OF THE DRAWINGS

The present invention will become more fully understood from the detailed description given hereinafter and the accompanying drawings which are given by way of illustration only, and thus are not limitative of the present invention, including:

FIG. 1 is a perspective view of a conventional lamp.

FIG. 2 is a perspective view of another conventional lamp.

FIG. 3 is an exploded and perspective view of a lamp of a first example according to a first embodiment of the present disclosure.

FIG. 4 is a cross-sectional view of the lamp of the first example when the lamp is settled on a fixed object.

FIG. 5 is an exploded and perspective view of a lamp of a second example according to the first embodiment of the present disclosure.

FIG. 6 is a cross-sectional view of the lamp of the second example when the lamp is settled on a fixed object.

FIG. 7 is a perspective view of a semi-finished plate made by punch, which serves to form a base of the lamp.

FIG. 8 is a perspective view of the base formed by bending parts of the semi-finished plate made by punch.

FIG. 9 is a perspective view of the base in bar shape.

FIG. 10 is a perspective view of the base in cross shape.

FIG. 11 is a perspective view of the base in Y shape.

FIG. 12 is a perspective view of a round plate serving as the base.

FIG. 13 is an exploded and perspective view of a lamp of a first example according to a second embodiment of the present disclosure.

FIG. 14 is a cross-sectional view of the lamp of the first example of the second embodiment when the lamp is settled on a fixed object.

FIG. 15 is an exploded and perspective view of a lamp of a second example according to the second embodiment of the present disclosure.

FIG. 16 is a cross-sectional view of the lamp of the second example of the second embodiment when the lamp is settled on a fixed object.

FIG. 17 is an exploded and perspective view of a lamp of a third example according to the second embodiment of the present disclosure.

FIG. 18 is a cross-sectional view of the lamp of the third example of the second embodiment when the lamp is settled on a fixed object.

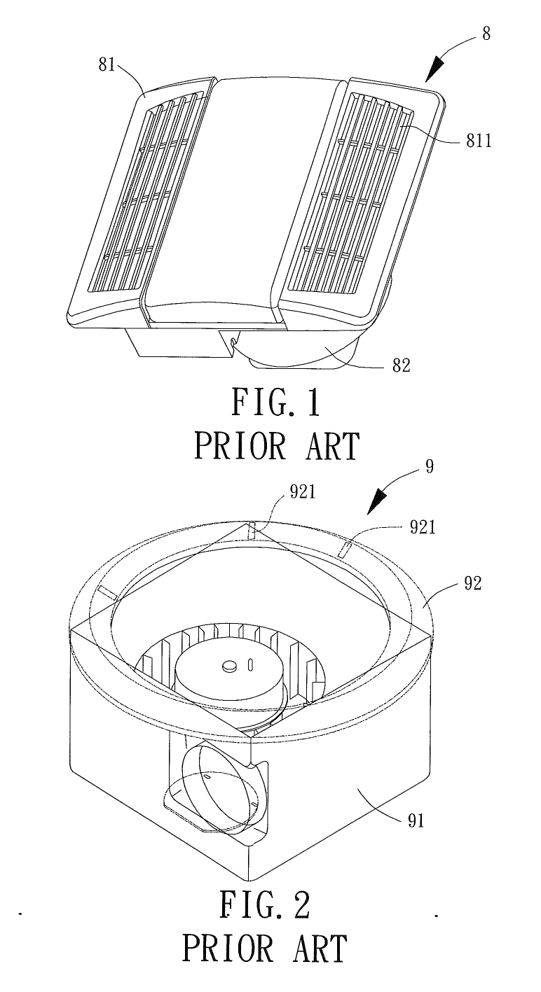

In the various figures of the drawings, the same numerals designate the same or similar parts. Furthermore, when the term “first,” “second,” “third,” “inner,” “outer,” “upper” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

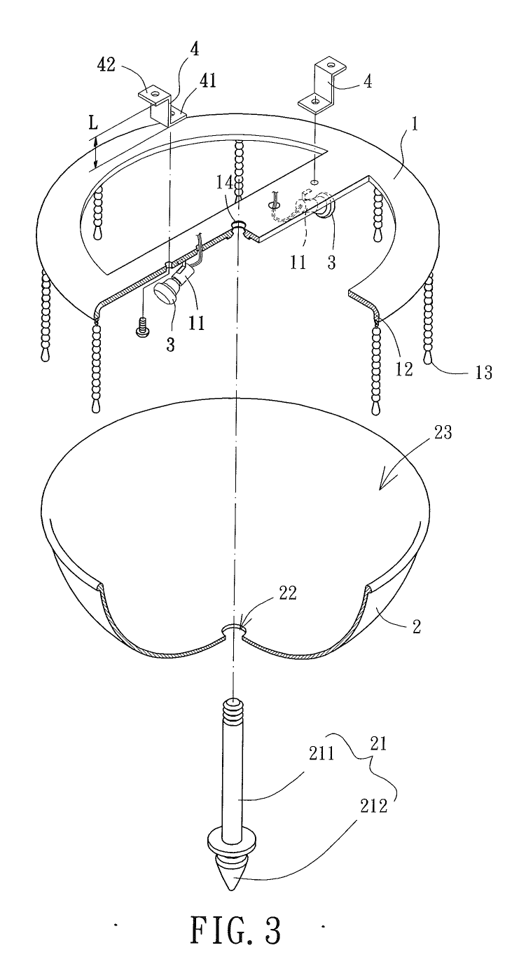

In FIGS. 3-12, a first embodiment of a lamp with airing function of the present invention is shown, which includes a base 1, a lampshade 2, a light emitter 3, and a distance holding member 4. The lampshade 2 connects with the base 1. The light emitter 3 is arranged between the base 1 and lampshade 2. The distance holding member 4 is adapted to firmly fix the positions of the base 1 and lampshade 2 relative to a fixed object “S,” such as a ceiling or a wall of a room, a decoration on the ceiling or wall, or any frame fixed to the ceiling or wall. In this embodiment, the fixed object “S” is a ceiling with an assembly hole “S1.”

The looks or shapes of the base 1 and lampshade 2 are not limited, as long as the base 1 and lampshade 2 can be coupled with each other. The way to couple the base 1 and lampshade 2 is also not limited, which can be performed by engaging, screwing, adhesion, etc.

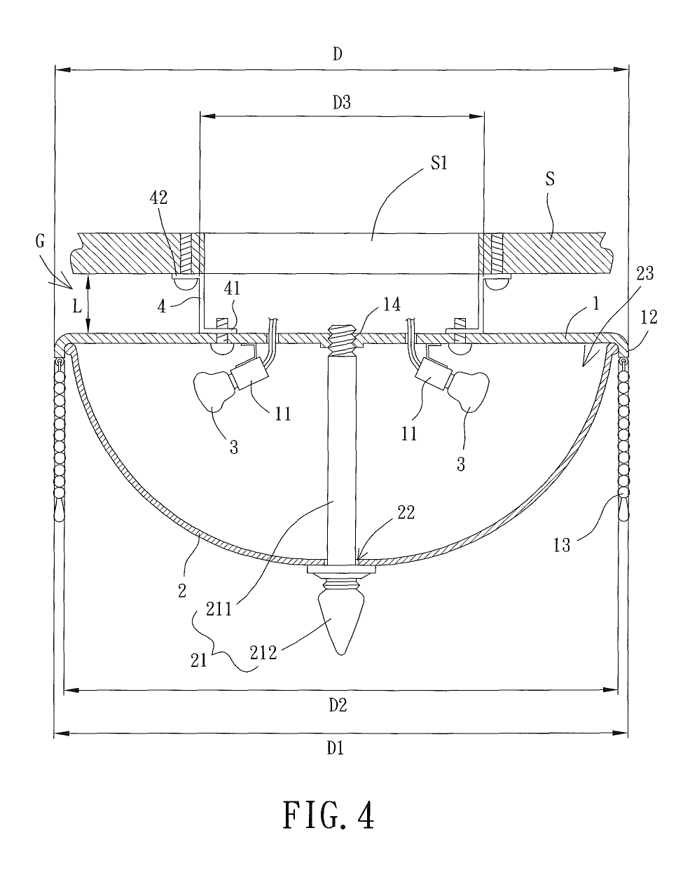

Referring to FIG. 4, the light emitter 3 arranged between the base 1 and lampshade 2 is received in a receiving space delimited by the base 1 and lampshade 2. The member for the light emitter 3 to couple is not limited, as long as the light emitter 3 can be firmly arranged in the receiving space.

The distance holding member 4 has a first connecting end 41 and a second connecting end 42 opposite to the first connecting end 41, and the distance holding member 4 further has an axial length “L” between the first and second connecting ends 41, 42. The first connecting end 41 is adapted to connect with the base 1, and the second connecting end 42 is adapted to connect with the fixed object “S.” The way to connect the first and second connecting ends 41, 42 with the base 1 and fixed object “S” is not limited, as long as the distance holding member 4 can be firmly fixed to the base 1 and fixed object “S.” In this embodiment, as shown in FIGS. 3 and 4, the first and second connecting ends 41, 42 respectively connect with the base 1 and fixed object “S” by screws. In this embodiment, there are two distance holding members 4 to support the combination of the base 1 and lampshade 2.

Referring to FIG. 4 again, when a ceiling serves as the fixed object “S” and has a through hole as the assembly hole “S1,” there is an airing gap “G” formed by the axial length “L” of the distance holding member 4 and between the base 1 and the fixed object “S.” In this embodiment, the width of the airing gap “G” equals the axial length “L,” and the air gap “G” communicates with an upper space above the ceiling via the assembly hole “S1.” Therefore, the heat generated by the light emitter 3 can be dissipated by airflow passing through the airing gap “a” so as to efficiently lower the operation temperature of the light emitter 3 and thus to improve the lifetime of the lamp. Preferably, in the situation with a fan arranged in the upper space above the ceiling, the airflow formed by the fan and passing through the airing gap “G” can be largely enhanced to further improve the cooling performance. According to the above structure of the first embodiment, a plurality of examples thereof is further illustrated as the following. Besides, in radial directions perpendicular to the axial length “L,” a lamp width “D” of the lamp is defined.

For the first example of the first embodiment as shown in FIGS. 3 and 4, the base 1 has an electrical connector 11 for linking the light emitter 3 to an electrical power source. Accordingly, the light emitter 3 can receive electrical power and generate light conveniently. An outer edge of the base 1 has a flange 12 covering an outer periphery of the lampshade 2, so as to enhance the coupling stability between the base 1 and lampshade 2. Preferably, there can also be a plurality of ornaments 13 hung on the flange 12 as decorations.

In this first example, in the radial directions, the base 1 has a first largest width “D1” and the lampshade 2 has a second largest width “D2” smaller than the first largest width “D1,” so that it is convenient to provide various designs about the outer edge of the base 1, such as the flange 12 or ornaments 13. Furthermore, according to FIG. 4, the lamp width “D” of the lamp is the largest width of the combination of the base 1 and lampshade 2, which equals to the first largest width “D1” in this first example. Preferably, in the radial directions, the distance holding member 4 is located within a range of the combination of the base 1 and lampshade 2. Specifically, when there are more than one distance holding member 4, there is a spacing distance “D3” between any two adjacent distance holding members 4. Moreover, the plurality of distance holding members 4 can be arranged on a virtual circle “C” in a plane perpendicular to the axial distance “L,” the spacing distance “D3” is the diameter of the virtual circle “C,” and the lamp width “D” is larger than the spacing distance “D3.” Accordingly, when the lamp is viewed from a position under the ceiling, the distance holding members 4 are totally covered by the base 1 or lampshade 2 and can avoid destroying the look of the settled lamp. Particularly, the spacing distance “D3” is smaller than or equal to ⅘ of the lamp width “D” for an ideal shading performance.

In the first example, the lamp further includes a support 21, which penetrates the lampshade 2 to perform the connection between the base 1 and lampshade 2. Particularly, the base 1 has a coupling portion 14 in the center, the lampshade 2 has a through hole 22 corresponding to the coupling portion 14, and the support 21 has a shaft 211 and a head 212 connecting with an end of the shaft 211. The shaft 211 extends through the through hole 22 and detachably connects with the coupling portion 14 of the base 1 by another end, with the head 212 abutting, supporting and positioning the lampshade 2. With the above structure, a user can easily disengage the lampshade 2 from the base 1 to clean the lampshade 2, change the lampshade 2 to another one, or exchange the light emitter 3. Although the head 212 can be integrally formed on the end of the shaft 211, it is preferable that the head 212 also detachably connects with the shaft 211, so that the support 21 can be in different shape when the head 212 switches between shapes of a drop, a crown and other decorative ones.

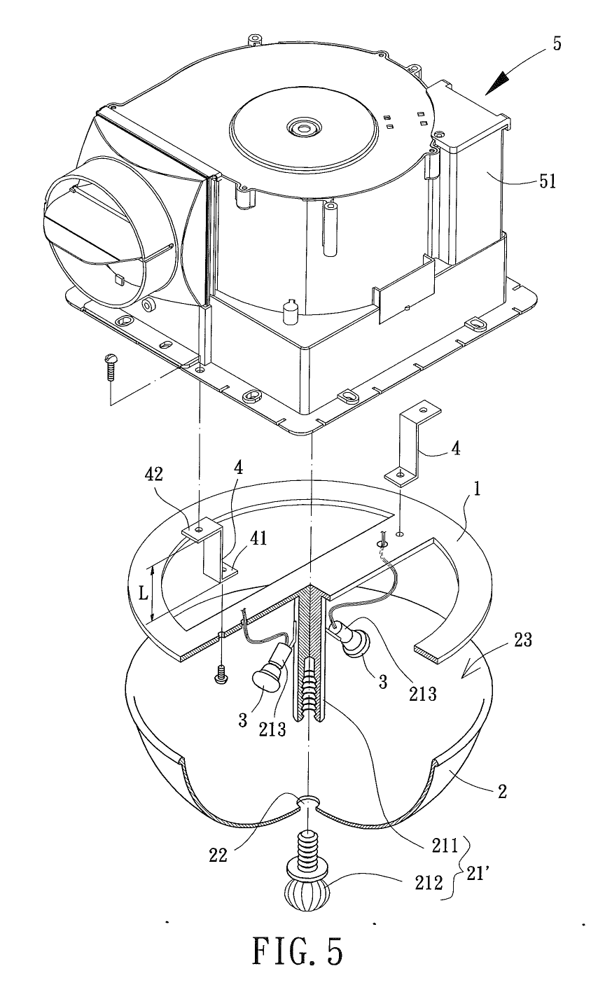

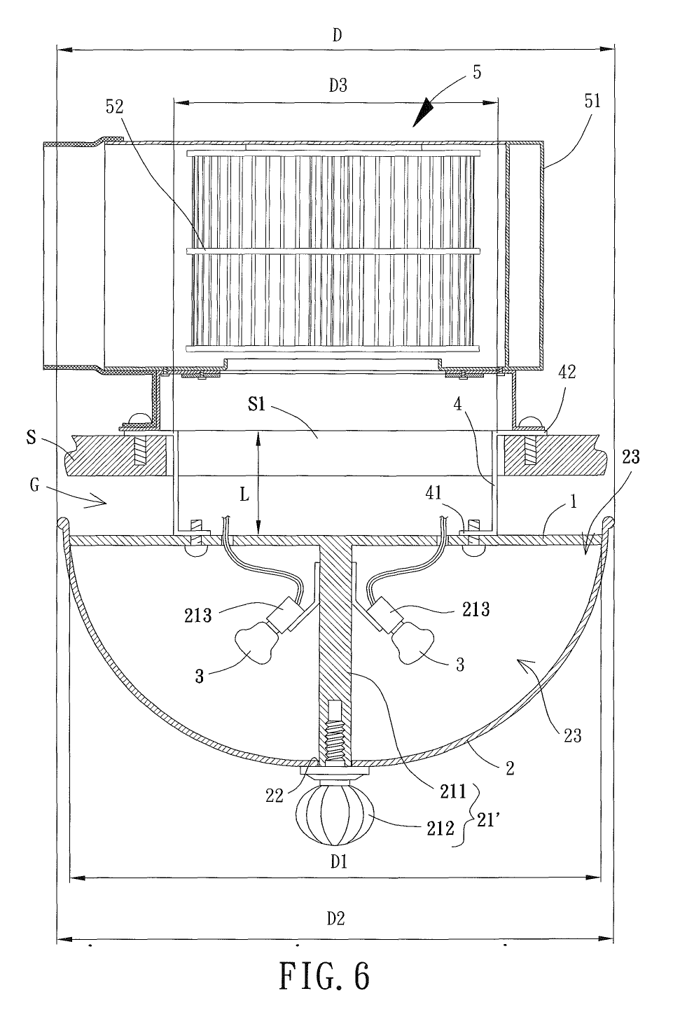

Referring to FIGS. 5 and 6, a second example of the first embodiment is shown. The main difference between this example and the first one lies in that the lamp further includes a fan 5 with a frame 51 and a fan wheel 52 received in the frame 51. The distance holding member 4 extends through the assembly hole “S1,” with the second connecting end 42 abutting against an inner side of the fixed object “S” facing away from the base 1, and with the fan 5 also arranged on the inner side by fixing the frame 51 to the second connecting end 42. Accordingly, the fan 5 can generate the airflow passing through the airing gap “G” for cooling.

In this second example, the second largest width “D2” of the lampshade 2 is larger than the first largest width “D1” of the base 1, and the lamp width “D” equals to the second largest width “D2.” In this example, the lampshade 2 has an opening 23, and the base 1 is received in the lampshade 2 and located at the opening 23. Furthermore, in this example, a support 21′ is used instead of the support 21 of the first example. The support 21′ also includes a shaft 211 and a head 212, but the shaft 211 is integrally formed on the base 1, with the head 212 detachably coupling with a free end of the shaft 211. Besides, an electrical connector 213 for linking the light emitter 3 to an electrical power source is arranged on a periphery of the shaft 211.

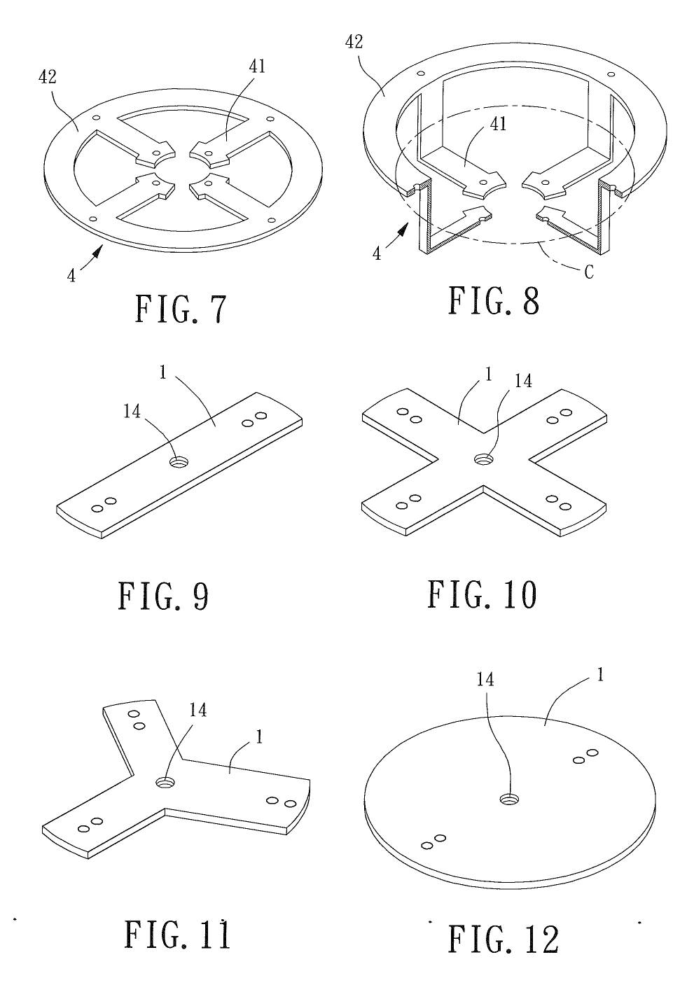

Regarding to the distance holding member 4 in the above described examples, it is preferable to form the distance holding member 4 by punch. For instance, FIG. 7 shows a semi-finished plate made by punch, which has the first and second connecting ends 41, 42 in the same plane, and FIG. 8 shows that parts of the semi-finished plate are bent to form the axial distance “L” between the first and second connecting ends 41, 42, wherein the first connecting end 41 is a plurality of supporting ribs with through holes, and the second connecting end 42 is a ring with through holes.

Referring to FIGS. 9-12, various kinds of base 1 to be used in this first embodiment are shown, which are bar-shaped, cross-shaped, Y-shaped and round plates respectively. Besides, the base 1 can also be a ring-shaped plate or be in the shape of a ring inwardly connecting with the free ends of the bar-shaped plate, the free ends of the cross-shaped plate, or the free ends of the Y-shaped plate.

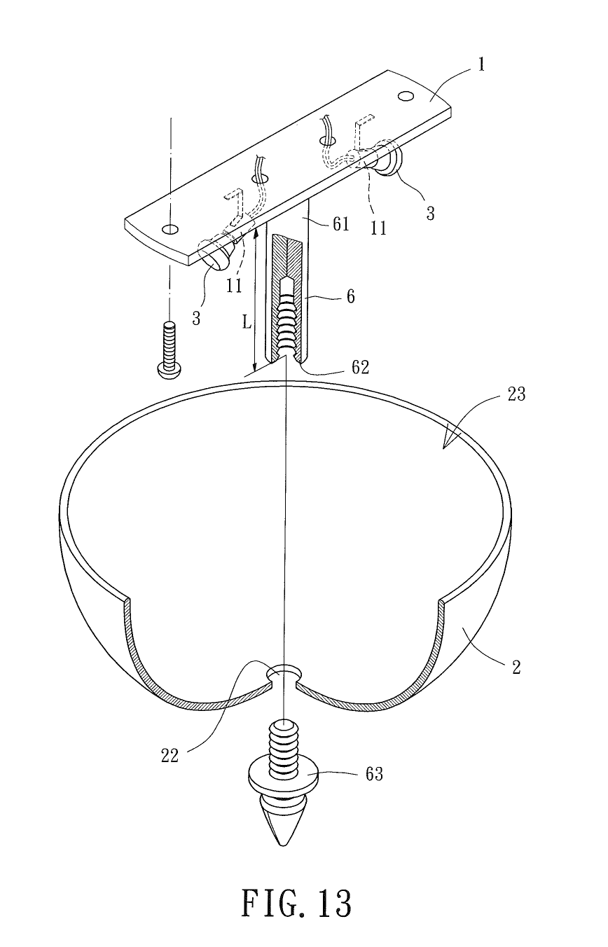

Now, referring to FIGS. 13-18, a second embodiment of a lamp with airing function of the present invention is shown, which includes a base 1, a lampshade 2, a light emitter 3, and a distance holding member 6, wherein the base 1 can also be a plate in the bar shape, cross shape, Y shape, or ring shape. In comparison with the first embodiment, instead of linking the base 1 and the fixed object “S” like the distance holding member 4, the distance holding member 6 of this embodiment is arranged between the base 1 and the lampshade 2. The distance holding member 6 has a first connecting end 61 and a second connecting end 62 opposite to each other, with the first connecting end 61 connecting with the base 1, and with the second connecting end 62 connecting with the lampshade 2. The axial length “L” is defined as the distance between the first and second connecting ends 61, 62, and the first and second largest width “D1,” “D2” are the largest widths of the base 1 and lampshade 2 in radial directions perpendicular to the axial length “L” of the distance holding member 6. Preferably, the first largest width “D1” is smaller than or equal to ⅘ of the second largest width “D2,” so that the lampshade 2 can completely cover the base 1. Besides, in the radial directions, both of the base 1 and distance holding member 6 are located within a range of the lampshade 2.

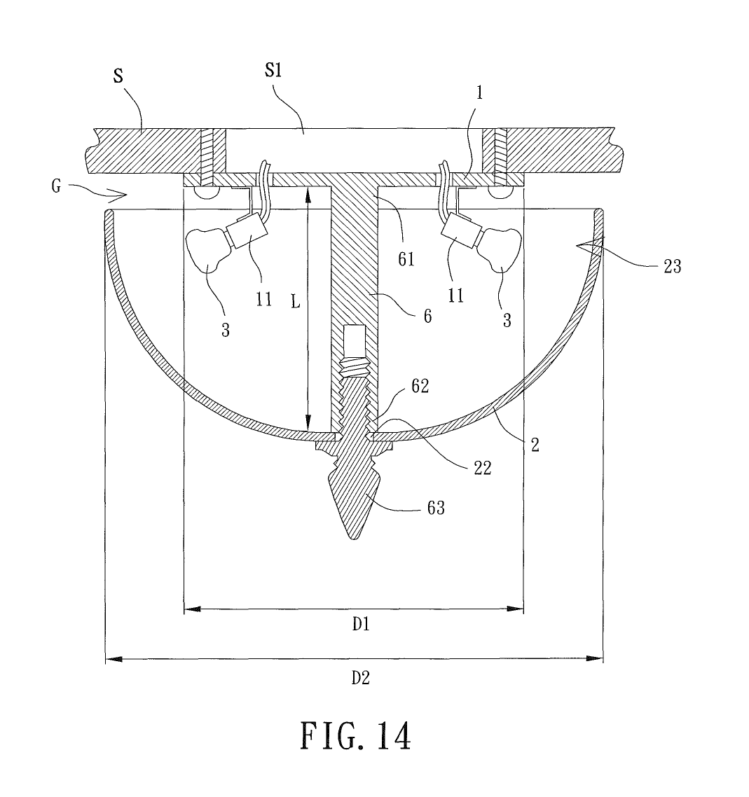

Referring to FIGS. 13 and 14, a first example of the second embodiment is shown. In this example, the distance holding member 6 is in the shape of a rod, and the second connecting end 62 has a hole aligning with the through hole 22 of the lampshade 2. A head 63 supports the lampshade 2, extends through the through hole 22 and engages with the second connecting end 62. With the above structure, a user can easily disengage the lampshade 2 from the base 1 to clean the lampshade 2, change the lampshade 2 to another one, or exchange the light emitter 3. Preferably, the head 63 can be switches between shapes of a drop, a crown and other decorative ones.

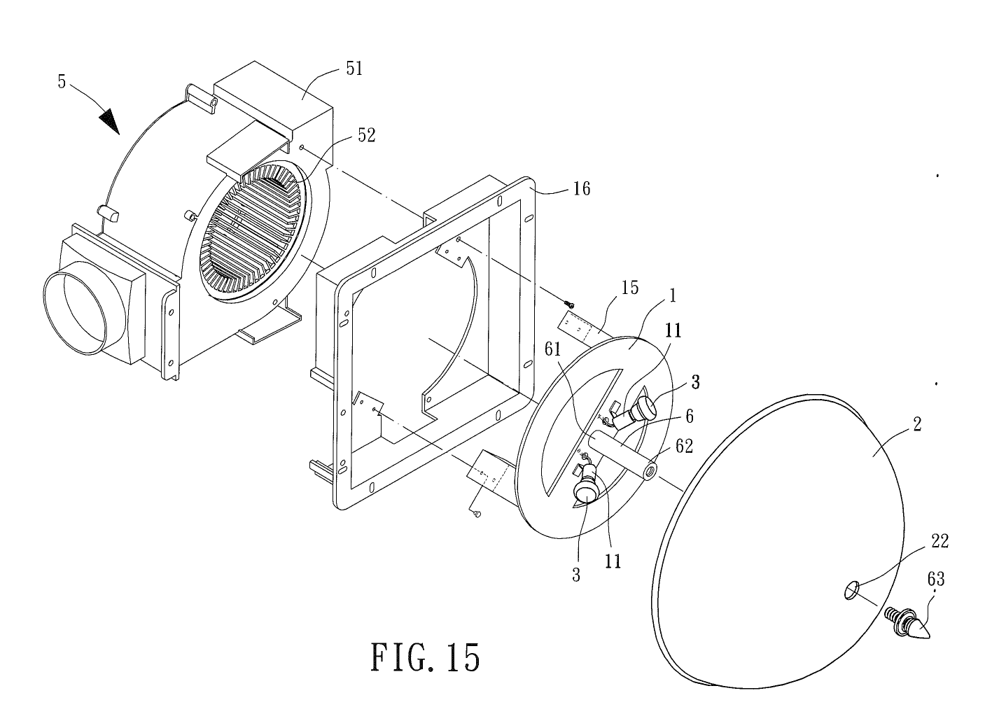

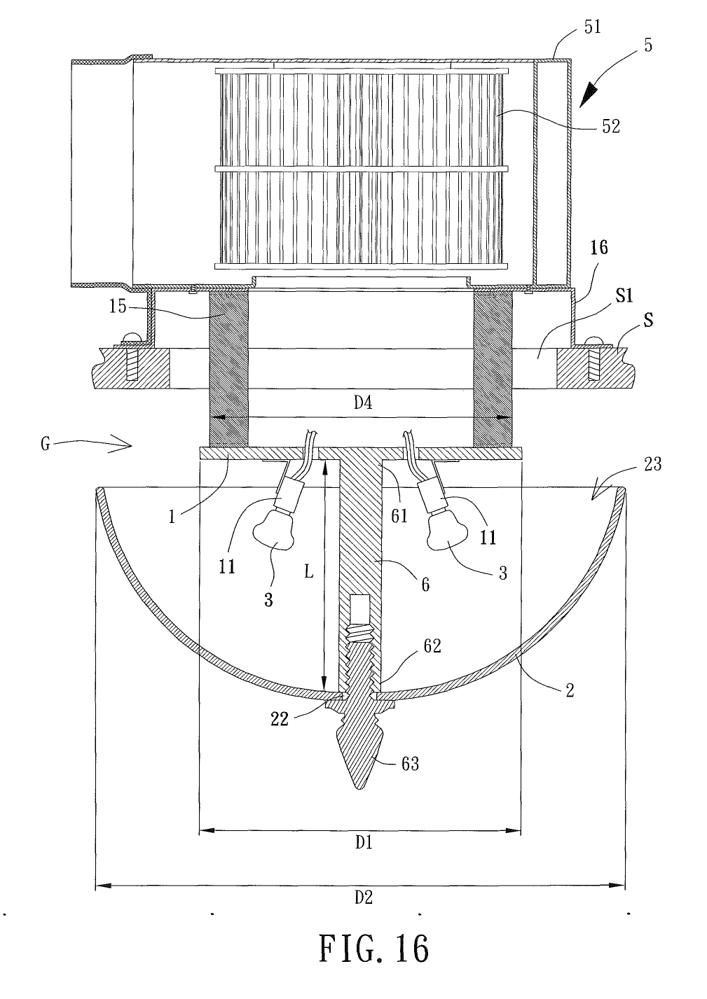

Referring to FIGS. 15 and 16, a second example of the second embodiment is shown. The main difference between this example and the first example lies in that the lamp further includes a fan 5 with a frame 51 and a fan wheel 52 received in the frame 51. The base 1 has an extending rib 15 extending through the assembly hole “S1” to abut against the inner side of the fixed object “S” facing away from the base 1. Preferably, the extending rib 15 further connects with a positioning frame 16 whereon the frame 51 mounts, and the positioning frame 16 couples with the inner side of the fixed object “S.” Preferably, the extending rib 15 is located within a range of the lampshade 2 in the radial directions perpendicular to the axial length “L.” Specifically, when there are more than one extending rib 15, there is a spacing distance “D4” between any two adjacent extending ribs 15, and the second largest width “D2” is larger than the spacing distance “D4.” Accordingly, when the lamp is viewed from a position under the ceiling, the extending ribs 15 are totally covered by the lampshade 2 and can avoid destroying the look of the settled lamp. Particularly, the spacing distance “D4” is smaller than or equal to ⅘ of the second largest width “D2” for an ideal shading performance.

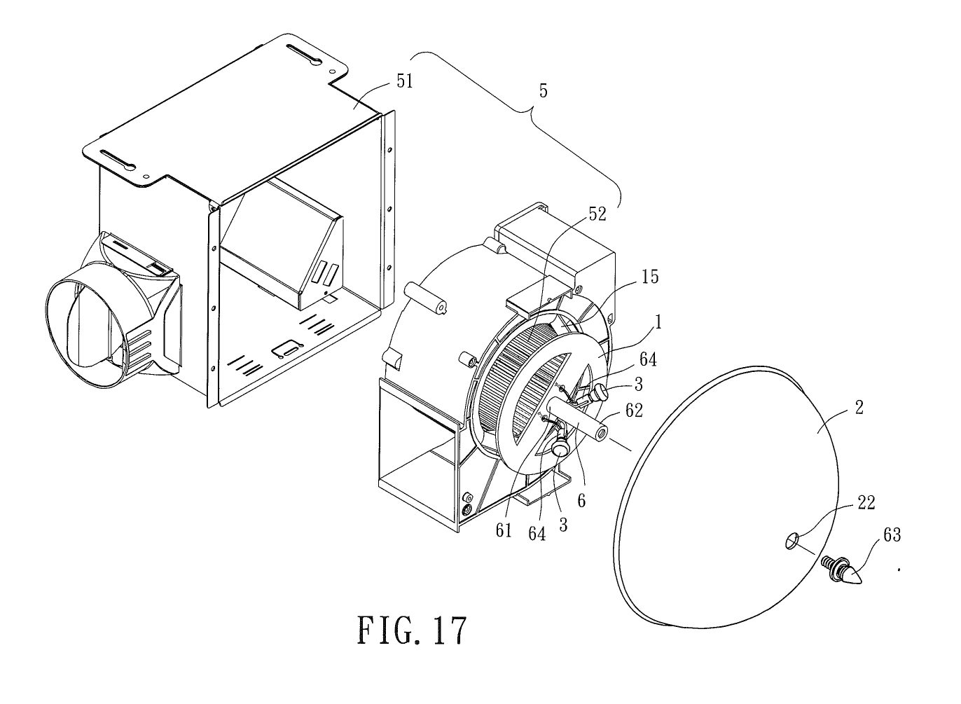

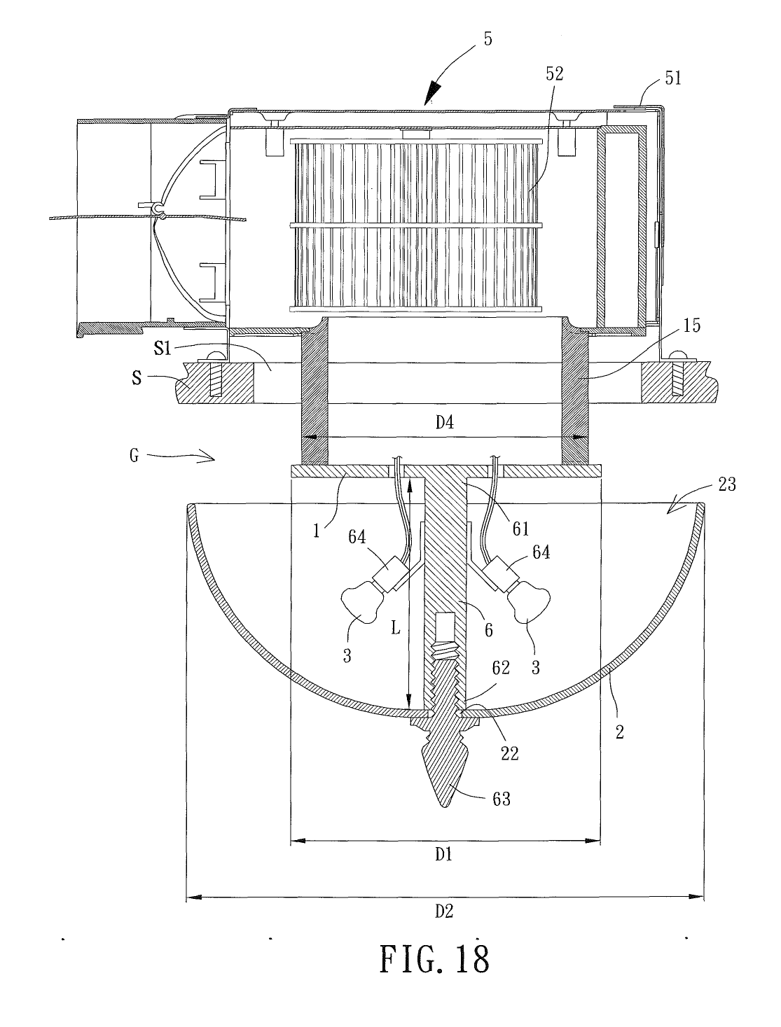

Referring to FIGS. 17 and 18, a third example of the second embodiment is shown. The main difference between this example and the second example lies in that the positioning frame 16 is omitted, the frame 51 is mounted on the fixed object “S” directly, and the base 1 directly connects with the frame 51 by the extending rib 15 so as to fix on the fixed object “S” through the frame 51. Therefore, components of this lamp and steps for assembling are further decreased. Besides, an electrical connector 64 for linking the light emitter 3 to an electrical power source is arranged on a periphery of the distance holding member 6.

In sum, with the above structure of the presented lamp, the distance holding members 4, 6 can surely form the airing gap “G” between the base 1 and the fixed object “S” or between the lampshade 2 and the fixed object “S.” As a result, it is unnecessary to form any opening other then the assembly hole “S1” in the fixed object “S”. Thus, It is easy to settle the presented lamp, and no additional cost for settling this lamp is needed.

Furthermore, with the design of the distance holding members 4, 6, this lamp can provide airing function by adaptation of existed elements in the lamp market. Besides, the look of this lamp is improved since there is no need to form any hole penetrating the lampshade 2.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A lamp with airing function, which is adapted to be mounted on a fixed object, comprising:
a base;
a lampshade connecting with the base;
a light emitter arranged between the base and the lampshade; and
a distance holding member having a first connecting end, a second connecting end opposite to the first connecting end, and an axial length between the first and second connecting ends, with the first connecting end connecting with the base and the second connecting end adapted to connecting with the fixed object;
wherein an airing gap is formed between the base and the fixed object by the axial length of the distance holding member.

2. The lamp with airing function as claimed in claim 1, wherein, in radial directions perpendicular to the axial length, the distance holding member is located within a range of a combination of the base and lampshade.

3. The lamp with airing function as claimed in claim 1, wherein, in radial directions perpendicular to the axial length, the base has a first largest width, and the lampshade has a second largest width smaller than the first largest width.

4. The lamp with airing function as claimed in claim 1 further comprising another distance holding member, wherein there is a spacing distance between the two distance holding members, and a largest width of a combination of the base and lampshade is defined as a lamp width and larger than the spacing distance.

5. The lamp with airing function as claimed in claim 4, wherein the distance holding members are arranged on a virtual circle, and the spacing distance is a diameter of the virtual circle.

6. The lamp with airing function as claimed in claim 4, wherein the spacing distance is smaller than or equal to ⅘ of the lamp width.

7. The lamp with airing function as claimed in claim 1, wherein, in radial directions perpendicular to the axial length, the base has a first largest width, and the lampshade has a second largest width larger than the first largest width.

8. The lamp with airing function as claimed in claim 7, wherein the lampshade has an opening and the base is received in the lampshade and located at the opening.

9. The lamp with airing function as claimed in claim 1 further comprising a support penetrating the lampshade to connect the lampshade with the base.

10. The lamp with airing function as claimed in claim 9, wherein the base has a coupling portion, the lampshade has a through hole corresponding to the coupling portion, the support has a shaft and a head connecting with an end of the shaft, the shaft extends through the through hole and connects with the coupling portion by another end, and the head supports and positions the lampshade.

11. The lamp with airing function as claimed in claim 10, wherein the head is integrally formed on the end of the shaft.

12. The lamp with airing function as claimed in claim 10, wherein the head is detachably connected with the end of the shaft.

13. The lamp with airing function as claimed in claim 9, wherein the lampshade has a through hole, the support has a shaft and a head connecting with an end of the shaft, the shaft extends through the through hole and integrally connects with the coupling portion by another end, and the head supports and positions the lampshade.

14. The lamp with airing function as claimed in claim 10, wherein an electrical connector is arranged on a periphery of the shaft, and the light emitter connects with the electrical connector.

15. The lamp with airing function as claimed in claim 13, wherein an electrical connector is arranged on a periphery of the shaft, and the light emitter connects with the electrical connector.

16. The lamp with airing function as claimed in claim 1, wherein the base has an electrical connector, and the light emitter connects with the electrical connector.

17. The lamp with airing function as claimed in claim 1 further comprising a fan with a frame and a fan wheel received in the frame.

18. The lamp with airing function as claimed in claim 17, wherein the distance holding member extends through the assembly hole, the second connecting end abuts against an inner side of the fixed object, and the frame is fixed to the second connecting end.

19. The lamp with airing function as claimed in claim 1, wherein an outer edge of the base has a flange covering an outer periphery of the lampshade.

20. The lamp with airing function as claimed in claim 19, wherein a plurality of ornaments is hung on the flange.

21. The lamp with airing function as claimed in claim 1, wherein the base is a bar-shaped plate.

22. The lamp with airing function as claimed in claim 1, wherein the base is a cross-shaped plate.

23. The lamp with airing function as claimed in claim 1, wherein the base is a Y-shaped plate.

24. The lamp with airing function as claimed in claim 1, wherein the base is a round plate.

25. The lamp with airing function as claimed in claim 1, wherein the base is a ring-shaped plate.

26. The lamp with airing function as claimed in claim 1, wherein the distance holding member is a punch-formed member.

27. The lamp with airing function as claimed in claim 26, wherein the first connecting end is a plurality of supporting ribs with through holes, and the second connecting end is a ring with through holes.

28. A lamp with airing function, which is adapted to be mounted on a fixed object, comprising:
a base adapted to connect with the fixed object;
a lampshade;
a light emitter arranged between the base and the lampshade; and
a distance holding member having a first connecting end, a second connecting end opposite to the first connecting end, and an axial length between the first and second connecting ends, with the first connecting end connecting with the base and the second connecting end connecting with the lampshade;
wherein an airing gap is formed between the lampshade and the fixed object by the axial length of the distance holding member.

29. The lamp with airing function as claimed in claim 28, wherein, in radial directions perpendicular to the axial length, the base has a first largest width, and the lampshade has a second largest width larger than the first largest width.

30. The lamp with airing function as claimed in claim 29, wherein the first largest width is smaller than or equal to ⅘ of the second largest width.

31. The lamp with airing function as claimed in claim 29, wherein, in radial directions perpendicular to the axial length, both of the base and distance holding member are located within a range of the lampshade.

32. The lamp with airing function as claimed in claim 28, wherein the lampshade has a through hole, the distance holding member has a rod, the second connecting end has a hole aligning with the through hole, and a head supports the lampshade, extends through the through hole and engages with the second connecting end.

33. The lamp with airing function as claimed in claim 28, wherein an electrical connector is arranged on a periphery of the distance holding member, and the light emitter connects with the electrical connector.

34. The lamp with airing function as claimed in claim 28, wherein the base has an electrical connector, and the light emitter connects with the electrical connector.

35. The lamp with airing function as claimed in claim 28 further comprising a fan with a frame and a fan wheel received in the frame.

36. The lamp with airing function as claimed in claim 35, wherein the base has an extending rib connecting with a positioning frame for the positioning frame to link the base and the fixed object.

37. The lamp with airing function as claimed in claim 36, wherein the frame of the fan mounts on the positioning frame.

38. The lamp with airing function as claimed in claim 35, wherein the base has an extending rib connecting with the frame.

39. The lamp with airing function as claimed in claim 36, wherein, in radial directions perpendicular to the axial length, the extending rib is located within a range of the lampshade.

40. The lamp with airing function as claimed in claim 38, wherein, in radial directions perpendicular to the axial length, the extending rib is located within a range of the lampshade.

41. The lamp with airing function as claimed in claim 36, wherein the base has another extending rib, there is a spacing distance between the two adjacent extending ribs, and the lampshade has a second largest width larger than the spacing distance.

42. The lamp with airing function as claimed in claim 38, wherein the base has another extending rib, there is a spacing distance between the two adjacent extending ribs, and the lampshade has a second largest width larger than the spacing distance.

43. The lamp with airing function as claimed in claim 41, wherein the spacing distance is smaller than or equal to ⅘ of the second largest width.

44. The lamp with airing function as claimed in claim 42, wherein the spacing distance is smaller than or equal to ⅘ of the second largest width.

45. The lamp with airing function as claimed in claim 27, wherein the base is a bar-shaped plate.

46. The lamp with airing function as claimed in claim 27, wherein the base is a cross-shaped plate.

47. The lamp with airing function as claimed in claim 27, wherein the base is a Y-shaped plate.

48. The lamp with airing function as claimed in claim 27, wherein the base is a ring-shaped plate.
